(19) United States
(12) Patent Application Publication
(10) Pub. No.: US 2012/0014627 A1
(43) Pub. Date: Jan. 19, 2012

(54) PULL-OUT GUIDE

(75) Inventors: Daniel Rehage, Bielefeld (DE); Daniel Reidt, Herford (DE)

(73) Assignee: Paul Hettich GMBH & Co. KG, Kirchlengern (DE)

(21) Appl. No.: 13/255,159

(22) PCT Filed: Mar. 4, 2010
(86) PCT No.: PCT/EP2010/052782

§ 371 Date: Oct. 3, 2011

(30) Foreign Application Priority Data
Mar. 11, 2009 (DE) 20 2009 001 963.2

(51) Int. Cl. F16C 29/04; F16C 29/10; F16C 33/58

(52) U.S. Cl. 384/49

(57) ABSTRACT

The invention relates to a pull-out guide (1, 1′), in particular for furniture or domestic appliances, comprising a guide rail (2) that can be fixed on a furniture body and a sliding rail (3) that is movably supported on the guide rail (2) by means of rolling elements (4), wherein the rolling elements (4) are held on a rolling element cage (5), wherein at least one sliding body (8, 8′, 8″, 8″', 8″″) is arranged in an interior space between the sliding rail (3) and the guide rail (2), which sliding body is movably supported on the guide rail (2), the sliding rail (3), and/or a central rail.

The present invention relates to a pull-out guide, in particular for furniture, comprising a guide rail that can be fixed on a furniture body and a sliding rail that is movably supported on the guide rail by means of rolling elements, wherein the rolling elements are held on a rolling element cage.

Pull-out guides are well-known in which one or more sliding rails are movably supported on a guide rail by means of rolling elements. In the case of such pull-out guides, the problem exists that, due to tolerances in the manufacturing process, the rails exhibit inaccuracies in the profile geometry, so that a uniformly smooth sliding motion is not achieved when moving the sliding rail. In addition, the problem exists that when pressure is brought to bear on the sliding rail, because of the tolerances it can tilt downwards or torsion of the sliding rail relative to the guide rail can occur.

It is the object of the present invention to provide a pull-out guide that guarantees a more even sliding motion.

This object is achieved by a pull-out guide having the features of claim 1.

According to the invention, there is at least one sliding body arranged in an interior space between the sliding rail and the guide rail, the sliding body being movably supported on the guide rail. Thus, a drooping down of the sliding rail and/or torsion can be reduced by means of the sliding body taking over a certain guidance function. Although the operator has to accept slightly higher displacement forces during sliding due to the arrangement of the sliding body between the sliding rail and the guide rail, a more even pull-out movement is achieved that is perceived as being of higher quality.

According to a preferred embodiment of the invention, the sliding body has a cylindrical shape, the longitudinal axis of which is aligned parallel to the sliding direction. This allows for the sliding body to not only lie linear to the guide rail or the sliding rail respectively, but also to be moved along a curved surface in a longitudinal direction. This improves the guidance properties of the sliding body, which can be formed optionally as a solid body, a hollow body, a jointed hollow body, or a spring.

Preferentially, the sliding body is arranged essentially interlocking, non-positive, or with little play between the sliding rail and the guide rail, so that the forces of friction caused by the sliding body do not become too strong but still guaranteeing a certain support function of the sliding body. The sliding body in the form of a biased coil spring also compensates for manufacturing tolerances.

In a further embodiment of the invention, the sliding body is designed as a magnet. As a result, the fixing of the sliding body to the sliding rail, or to the guide rail, or to the rolling element cage can take place in a simple manner. It is additionally possible, that when the sliding body is designed as a magnet, it results in a locking of the sliding rail to the guide rail in a predetermined position. In particular, the sliding body can be detachably fixed by magnetic forces to a projection of the sliding rail or of the guide rail, which leads to a corresponding locking. In addition, the magnetic forces can be so aligned that the guide rail and the sliding rail are held together in a direction perpendicular to the sliding direction. Magnetic fields can be axial or radial. Furthermore, a formation of eddy currents in the sense of an eddy current brake is feasible in order to achieve a “cushioning” effect. Moreover, due to the eddy currents a hard impact of the profiles into the end positions can be reduced or even prevented.

In an embodiment, the sliding body is fixed frontally to the rolling element cage. The rolling element cage can be extended by means of the sliding body, thus ensuring a better guidance of the sliding rail on the guide rail.

In a further embodiment, the sliding body has a coating with low friction coefficient. In particular, the sliding body may have a Teflon coating, a solid lubricant, in particular with carbon, boron nitride or other suitable materials.

For particularly good sliding rail guidance, at least one sliding body can be arranged on both sides of the rolling element cage. In the case of a sliding motion, both the front as well as the rear sliding body can have an appropriate guidance function. Furthermore, multiple tracks with rolling elements can be placed between the guide rail and the sliding rail, with at least one sliding body arranged on each track. Usually, several tracks are in a plane perpendicular to the sliding direction so that multiple sliding bodies can take over appropriate guidance functions.

In a simple embodiment, the sliding body can be cylindrical in shape. To enable a better sliding motion and to avoid the displacement of lubricant by the sliding body, the sliding body can have grooves in its longitudinal extension. Lubricant can flow through these grooves past the sliding body.

The sliding bodies in the different tracks can also be connected to each other in order to enable parallel sliding of the sliding bodies.

In a further embodiment, the sliding body has a damper on a side face so that loud impact noises can be avoided. The damper can be made of an elastic material, especially rubber or foam.

In a further embodiment, it is possible to form the sliding body as a coil spring so that a guidance function as well as a damping function is obtained when reaching a stop. Furthermore, a latch in the end positions is achieved with a coil spring as a sliding body. In particular, the tapered end of the coil spring can be set temporarily to latch between a stop of the pull-out guide and the rolling element cage and/or between a stop and the sliding rail or guide rail of a pull-out guide.

The invention will subsequently be described in more detail on the basis of two embodiments with reference to the enclosed drawings, wherein:

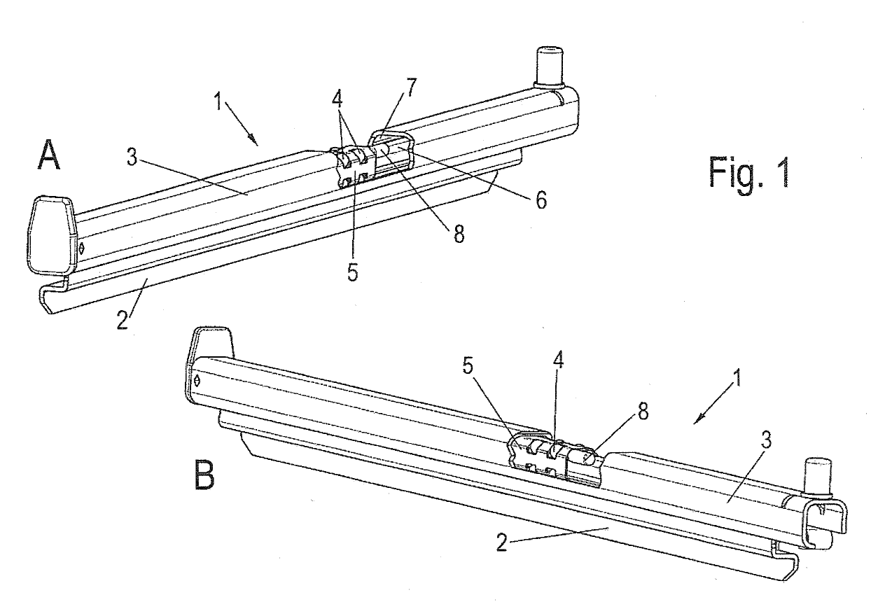

FIGS. 1A and 1B show two views of a pull-out guide according to the invention;

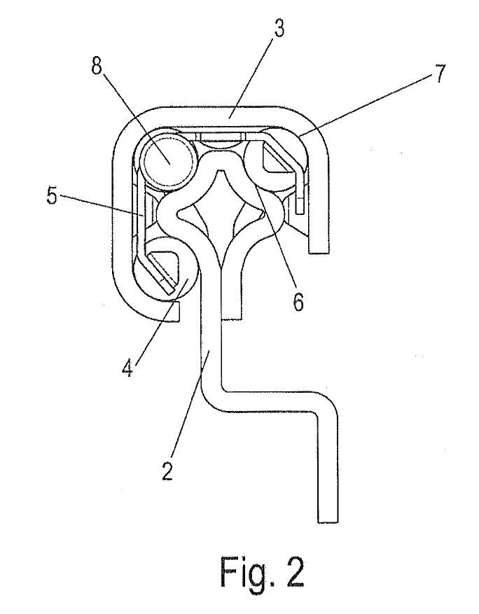

FIG. 2 shows a cross-sectional view of the pull-out guide of FIG. 1;

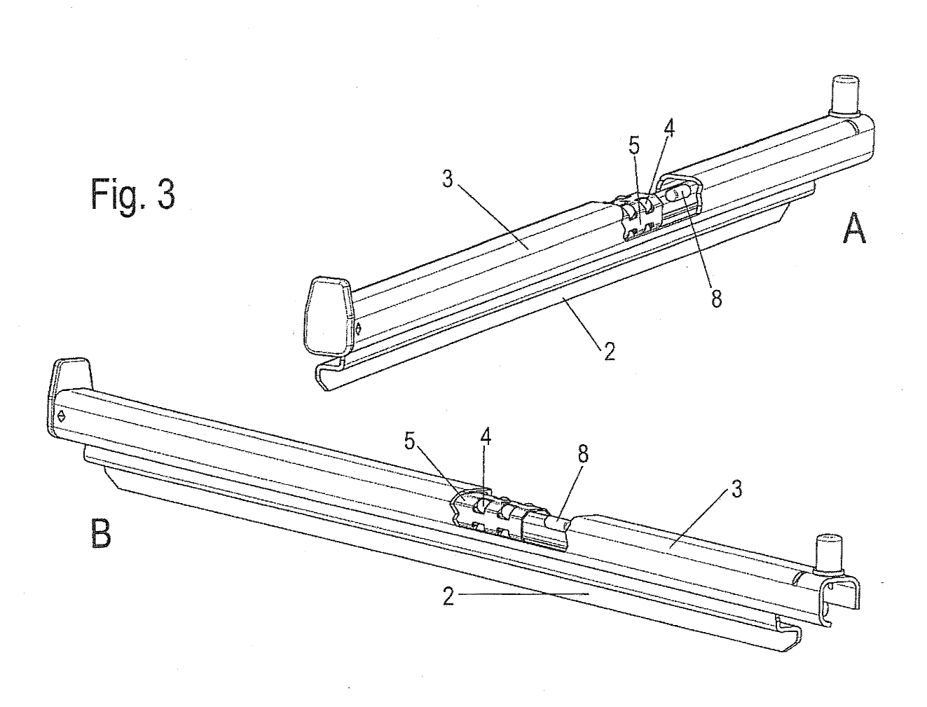

FIGS. 3A and 3B show two views of a modified pull-out guide and

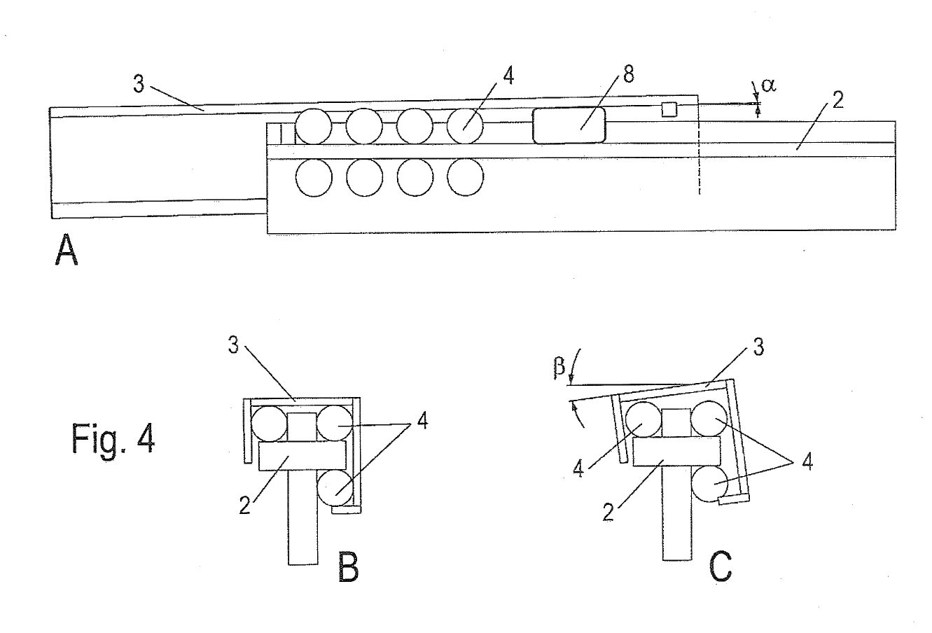

FIGS. 4A to 4C show schematic views of a pull-out guide under various load conditions.

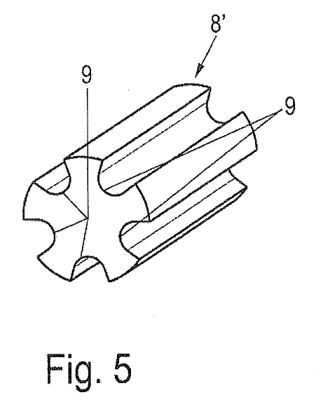

FIGS. 5 to 7 show examples of sliding body variations;

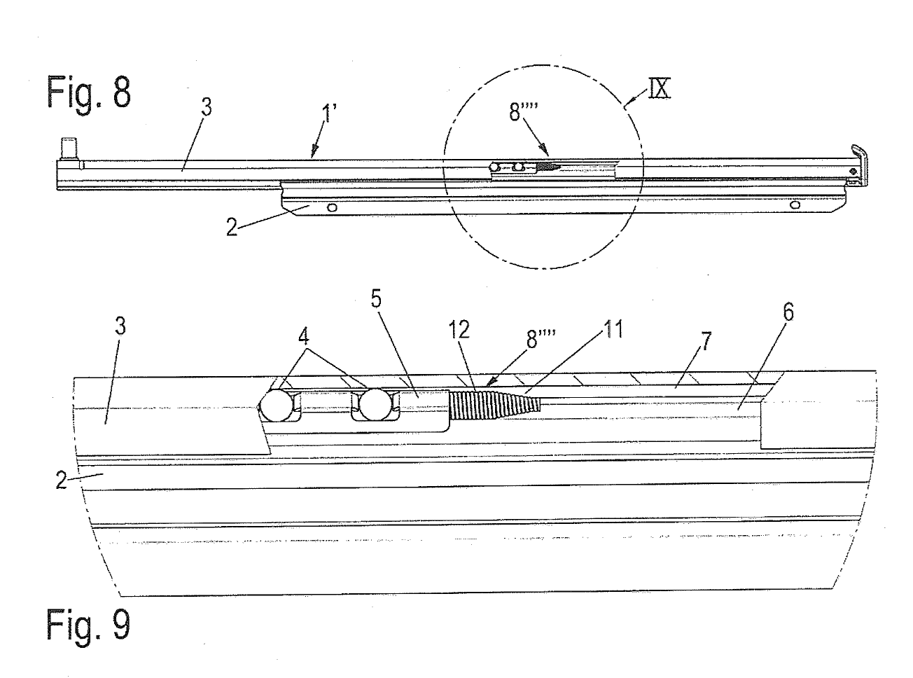

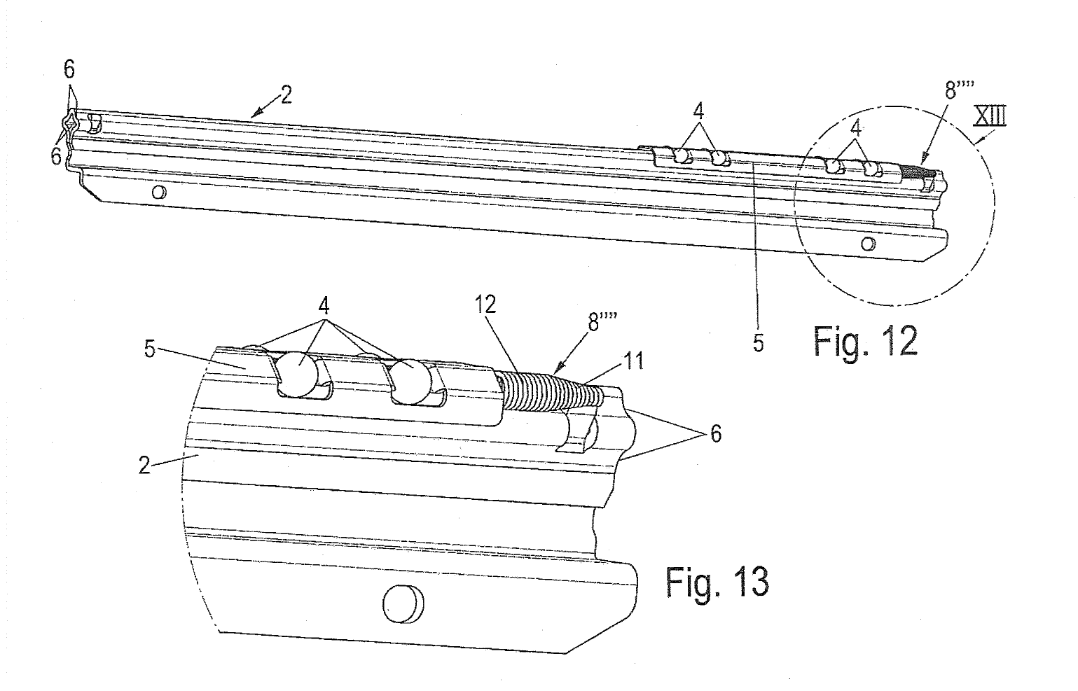

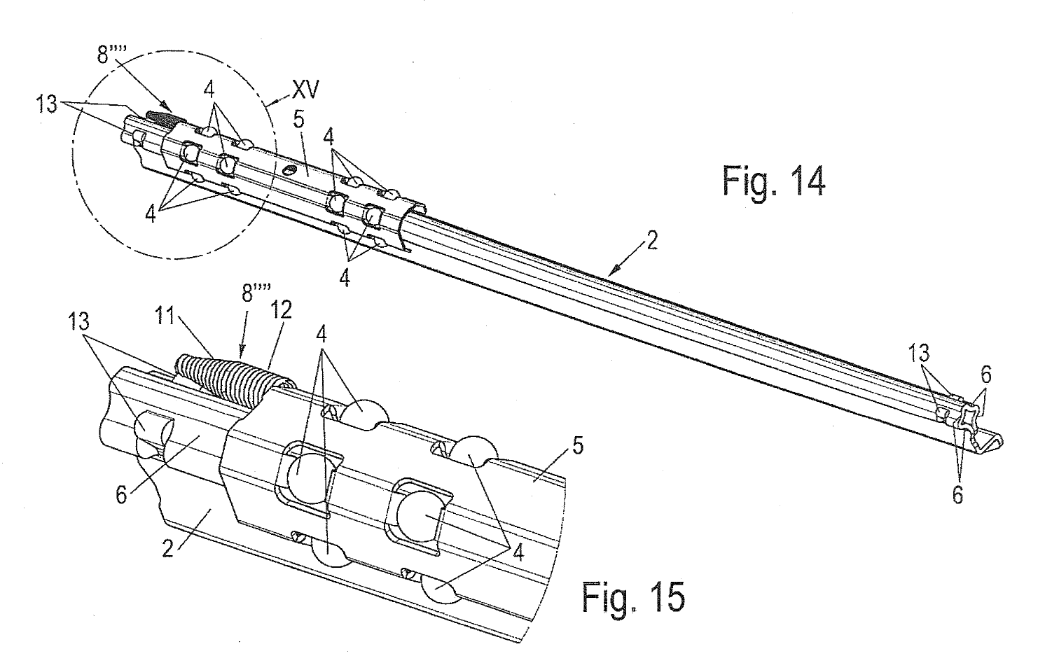

FIGS. 8 to 15 show views of a further pull-out guide according to the invention.

A pull-out guide 1 comprises a guide rail 2 that in particular can be fixed on a furniture body. A sliding rail 3 is movably supported on the guide rail 2 by means of rolling elements 4. It is also possible to design the pull-out guide 1 as fully extendable or over-extendable respectively, so that between the guide rail 2 and the sliding rail 3 at least one movably supported central rail is arranged.

On the guide rail 2, several tracks 6 extending in a longitudinal direction are formed for the rolling elements 4 that roll opposite each other along several tracks 7 on the sliding rail 3. In a plane perpendicular to the sliding direction, three rolling elements 4 are provided respectively, wherein only two or more rolling elements can be arranged between the sliding rail 3 and the guide rail 2. In this case, several rolling elements 4 are arranged in a row and held on a rolling element cage 5.

At one end face of the rolling element cage 5 there is a sliding body 8 manufactured in a solid cylindrical form, in particular from metal or plastic, and which is arranged in the interior of the sliding rail 3 between the guide rail 2 and the sliding rail 3.

As seen particularly in FIG. 2, the sliding body 8 has little play so that the frictional forces are kept low during movement of the sliding rail 3. The sliding body 8 takes over a guidance function when, due to unevenness of the track 6 or 7 or other tolerance-induced deviations, the sliding rail 3 and the guide rail 2 simultaneously abut the sliding body 8. Especially when pulling out the sliding rail 3, there is usually some droop so that then the sliding rail 3 and the guide rail 2 are no longer arranged exactly parallel and the sliding body 8 forms a guidance in order to minimize the misalignment as much as possible. In addition, the sliding body 8 has certain cushioning properties to allow for even movement of the sliding rail 3.

The sliding body 8 is manufactured from a magnetic material, in particular from AlNiCo or from another ferromagnetic material that has a remanence of at least 500 mT, especially more than 800 mT. The maximum operating temperature for AlNiCo is approximately 450° C., so that use in a baking oven is possible without a problem.

Due to the magnetic design of the sliding body 8, it is fixed to the rolling element cage 5 at a front face and is moved together with the rolling elements 4. When the sliding rail 3 reaches a maximum end position either fully pulled out or fully pushed in, a corresponding stop can be formed on the guide rail and at which stop the sliding body 8 provides a latch mechanism. The magnetic forces can thus be so calculated that the retention forces on the rolling element cage 5 are larger than on the projection of the guide rail. In this way, the sliding rail 3 can be detachably fixed in a desired position.

In the FIGS. 3A and 3B, a slightly modified design of a pull-out guide is shown in which a sliding rail 3 is movably supported at a guide rail 2 by means of rolling elements 4. In this embodiment, the sliding body 8 is arranged spaced apart from the rolling element cage 5 and can be fixed at the sliding rail 3. In an end position of the sliding rail 3, the sliding body 8 can then fit closely against the rolling element cage 5, also by exploiting magnetic retention forces if necessary.

In the FIGS. 4A to 4C, the pull-out guide is schematically depicted under various loads. In FIG. 4A, the sliding rail 3 is shown in an extended position in which the sliding rail 3 is arranged inclined at the angle α to the horizontal or to the guide rail 2 respectively. Through the use of the sliding body 8, the length of the guide elements is increased because, in addition to the rolling elements, the sliding body 8 also contributes towards the guidance. In this manner, the droop is reduced by an angle α. In FIG. 4A, the sliding body 8 is depicted only on one side of the rolling elements 4, wherein, of course, a corresponding sliding body 8 can be arranged on opposing sides. The sliding body 8 forms a magnetic field that “connects” the sliding rail 3 and the guide rail 2 to each other.

In FIG. 4B, the sliding rail 3 is shown in a regularly aligned position in which all the rolling elements 4 are arranged in the corresponding tracks. In FIG. 4C, torsion of the sliding rail 3 is depicted, which can occur due to a torque, so that the sliding rail 3 is inclined at an angle β to the horizontal plane. In such a case, the rolling elements 4 are loaded differently because the torsion of the sliding rail 3 shifts the points of contact of the rolling elements 4. Even with such a torsional load, the sliding body 8 helps to improve the guidance of the sliding rail 3 at the guide rail 3.

In the depicted embodiment, with the pull-out guide 1 only one sliding body 8 is arranged at one side of the rolling element cage 5. It is, of course, possible to provide each track 6 or 7 respectively with a sliding body 8, thus sliding body 8 with the depicted embodiment 3. Additionally, sliding bodies 8 can also be provided at the opposing sides of the rolling element cage 5, so that six sliding bodies 8 are arranged between the sliding rail 3 and the guide rail 2.

In the depicted embodiment, the sliding body 8 is made from magnetic material as a solid body. The magnetic forces can thereby hold the guide rail 2 and the sliding rail 3 together in a direction perpendicular to the longitudinal direction. It is also possible to provide the sliding body 8 with a friction-reducing coating, so that the pull-out guide 1 runs smoothly.

The sliding body 8′ shown in FIG. 5 has several grooves 9 extending in a longitudinal direction in order to allow lubricant to flow though. This prevents lubricant from accumulating in front of the sliding body 8′ when operating the pull-out guide 1, and thus from causing a lubricant deficiency in the respective areas behind the track 6.

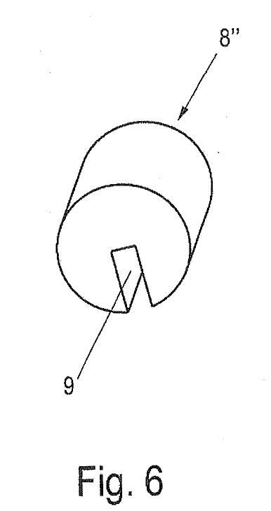

The sliding body 8″ shown in FIG. 6 has a groove 9 in order to allow lubricant to flow through. This prevents lubricant from accumulating in front of the sliding body 8″ when operating the pull-out guide 1, and thus from causing a lubricant deficiency in the respective areas behind the track 6.

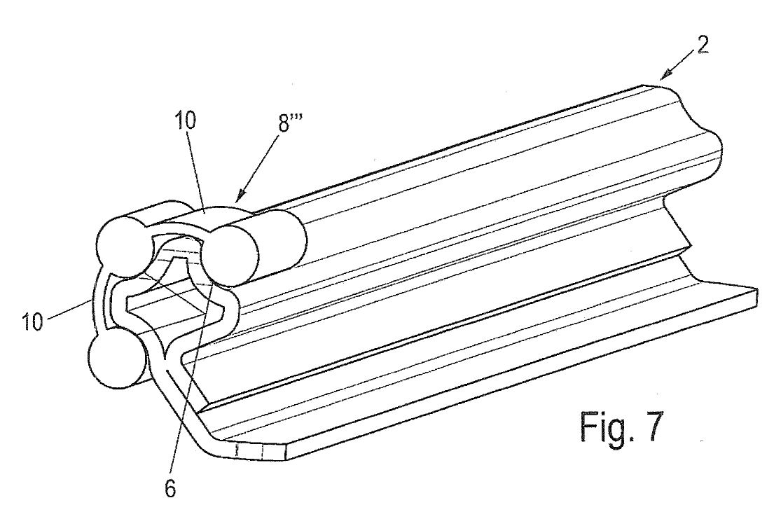

The sliding body 8″ shown in FIG. 7 has connecting webs 10 in order to allow for a smooth operation of the sliding body 8″ in all the tracks 6. This prevents elements of the sliding body 8″ being placed at different positions of the pull-out guide 1 when it is being operated.

The FIGS. 8 to 15 show a further embodiment according to the invention of a sliding body 8″″ in the form of a coil spring. The sliding body 8″″ has a cone-shaped area 11 and a cylinder-shaped area 12. The cylinder-shaped area 12 has approximately the same diameter as that formed by the tracks 6 and 7, while the cone-shaped area 11 tapers.

The FIGS. 8 and 9 show the sliding body 8″″ in a central position of the pull-out guide 1′. In this area, the sliding body 8″″ can bring about only a small force in the direction of the tracks 6 and 7.

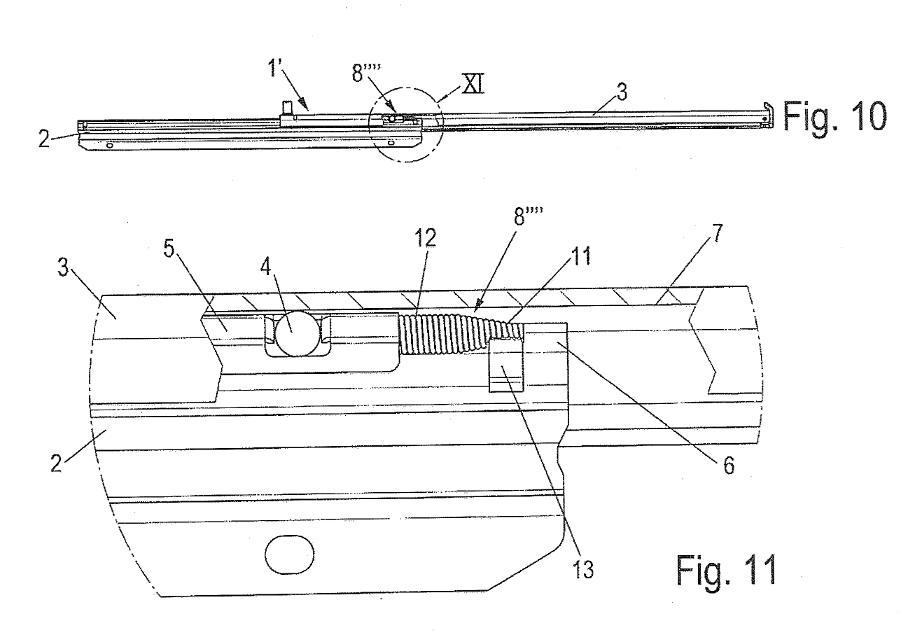

The FIGS. 10 to 15 show the pull-out guide 1′ in its maximally extended position. The conical area of the sliding body 8″″ lies between a stop 13 and the track 7 of the sliding rail 3. In this position, the sliding body 8″″ brings about a releasable latching of the pull-out guide 1′ when in an open state. In this position, utensils such as cooking trays can be safely placed by the operator on a pair of such pull-out guides 1′. By the operator overcoming a small counter force, the latching can be released and the pull-out guide 1′ can, for example, be pushed back into the oven of a household appliance.

In addition, the sliding body 8, 8′ can also be designed as a coil spring, formed from a hollow body or as a flexible hollow body.

### Drawing References

1 Pull-out Guide
1′ Pull-out Guide
2 Guide Rail
3 Sliding Rail
4 Rolling Element
5 Rolling Element Cage
6 Track
7 Track
8 Sliding Body
8′ Sliding Body
8″ Sliding Body
8″′ Sliding Body
8″″ Sliding Body

9 Groove
10 Connecting Web
11 Cone-shaped Area
12 Cylinder-shaped Area
12 Stop
α Angle
β Angle

1. Pull-out guide (1, 1′), in particular for furniture or house-hold appliances, comprising a guide rail (2) that can be fixed on a furniture body and a sliding rail (3) that is movably supported on the guide rail (2) by means of rolling elements (4), wherein the rolling elements (4) are held on a rolling element cage (5), characterized in that at least one sliding body (8, 8′, 8″, 8″′, 8″″) is arranged in an interior space between the sliding rail (3) and the guide rail (2), which sliding body is movably supported on the guide rail (2), the sliding rail (3), and/or a central rail.

2. Pull-out guide according to claim 1, characterized in that the sliding body (8, 8′, 8″, 8″′, 8″″) has a cylindrical shape, the longitudinal axis of which is aligned parallel to the sliding direction.

3. Pull-out guide according to claim 1, characterized in that the sliding body (8, 8′, 8″, 8″′, 8″″), arranged essentially interlocking, non-positive, and/or with little play, lies between the sliding rail (3) and the guide rail (2).

4. Pull-out guide according to claim 1, characterized in that the sliding body (8, 8′, 8″, 8″′, 8″″) is designed as a magnet.

5. Pull-out guide according to claim 1, characterized in that the sliding body (8, 8′, 8″, 8″′, 8″″) is designed as a coil spring.

6. Pull-out guide according to claim 1, characterized in that the sliding body (8, 8′, 8″, 8″′, 8″″) is fixed to the rolling element cage (5) at front face.

7. Pull-out guide according to claim 1, characterized in that the sliding body (8, 8′, 8″, 8″′, 8″″) has a coating with low friction coefficient.

8. Pull-out guide according to claim 1, characterized in that, by means of the sliding body (8, 8′, 8″, 8″′, 8″″) being designed as a magnet, a latching of the sliding rail (3) at the guide rail (2) can be accomplished.

9. Pull-out guide according claim 2, characterized in that at least one sliding body (8, 8′, 8″, 8″′, 8″″) is arranged on each side of the rolling element cage (5).

10. Pull-out guide according to claim 1, characterized in that the sliding body (8, 8′, 8″, 8″′, 8″″) has a damper arranged on at least one front face.

11. Pull-out guide according to claim 1, characterized in that multiple tracks (6, 7) with rolling elements (4) are arranged at a guide rail (2) and a sliding rail (3), with at least one sliding body (8, 8′, 8″, 8″′, 8″″) arranged on each track.

12. Pull-out guide according to claim 1, characterized in that the magnetic field formed by the sliding body (8, 8′, 8″, 8″′, 8″″) is radial.

13. Pull-out guide according to claim 1, characterized in that the magnetic field formed by the sliding body (8, 8′, 8″, 8″′, 8″″) is axial.

14. Pull-out guide according to claim 1, characterized in that a latching of the sliding rail (3) is enabled by the sliding body (8, 8′, 8″, 8″′, 8″″).
